(19) United States
(12) Patent Application Publication
(10) Pub. No.: US 2014/0268637 A1
(43) Pub. Date: Sep. 18, 2014

(54) WAVELENGTH CONVERTING STRUCTURE AND MANUFACTURING METHOD THEREOF

(71) Applicants: Yun-Li Li, Tainan City (TW); Gwo-Jiun Sheu, Tainan City (TW); Tai-Cheng Tsai, Tainan City (TW)

(72) Inventors: Yun-Li Li, Tainan City (TW); Gwo-Jiun Sheu, Tainan City (TW); Tai-Cheng Tsai, Tainan City (TW)

(73) Assignee: Genesis Photonics Inc., Tainan City (TW)

(21) Appl. No.: 14/203,588

(22) Filed: Mar. 11, 2014

(30) Foreign Application Priority Data
Mar. 14, 2013 (TW) 102109082

(51) Int. Cl. F21K 99/00; B29C 43/18; B29D 11/00

(52) U.S. Cl. CPC F21K 9/56; B29D 11/0073; B29C 43/184
USPC 362/84; 264/1.24

(57) ABSTRACT

A wavelength converting structure suitable for covering a carrier carrying at least one light-emitting diode (LED) chip is provided. The wavelength converting structure includes a base film and a fluorescent layer. The base film has a first bending portion and a first flat portion connected to the first bending portion. The first flat portion is disposed on the carrier, and an accommodating space is defined by the first bending portion and the carrier. The LED chip is disposed in the accommodating space. The fluorescent layer is disposed on the base film and has a second bending portion and a second flat portion connected to the second bending portion. The second bending portion is conformal to the first bending portion, and the second flat portion is conformal to the first flat portion.

### CROSS-REFERENCE TO RELATED APPLICATION

This application claims the priority benefit of Taiwan application serial no. 102109082, filed on Mar. 14, 2013. The entirety of the above-mentioned patent application is hereby incorporated by reference herein and made a part of this specification.

### BACKGROUND OF THE INVENTION

1. Field of the Invention

The invention relates to a wavelength converting structure and a manufacturing method thereof. Particularly, the invention relates to a wavelength converting structure adapted to a light-emitting diode (LED) chip and a manufacturing method thereof

2. Description of Related Art

Since a light-emitting diode (LED) has advantages of long lifespan, small volume, high shock resistance, low heat generation and low power consumption, etc., it is widely used as indicators or light sources in home appliance and various apparatuses. In recent years, the LED is developed towards a trend of multi-color and high brightness, and an application field thereof has been extended to large-scale outdoor billboards, traffic light and related fields. In the future, the LED may even become a main illumination light source having both power saving and environmental friendly features.

Regarding a manufacturing method of a conventional LED package structure, the LED chip is first disposed on a base, and then a fluorescent layer is formed on the LED chip through a mold filling method. However, the fluorescent layer formed through the mold filling method is easy to produce bubbles therein, which influences a refractive index of the fluorescent layer and an appearance thereof. Moreover, by using the mold filling method, the fluorescent layer directly contacts the LED chip, and a wavelength converting efficiency of the fluorescent layer is attenuated under heat, which leads to problems of brightness decrease and color shift of the whole LED package structure. Moreover, by using the mold filling method, the amount of the fluorescent adhesive and position of the fluorescent powder at a junction of the base and the fluorescent layer cannot be controlled.

### SUMMARY OF THE INVENTION

The invention is directed to a wavelength converting structure, which has a better device characteristic.

The invention is directed to a method for manufacturing a wavelength converting structure, which is used to manufacture the aforementioned wavelength converting structure.

The invention provides a wavelength converting structure, which is adapted to cover a carrier carrying at least one light-emitting diode (LED) chip. The wavelength converting structure includes a base film and a fluorescent layer. The base film has a first bending portion and a first flat portion connected to the first bending portion. The first flat portion is disposed on the carrier, and an accommodating space is defined by the first bending portion and the carrier. The LED chip is disposed in the accommodating space. The fluorescent layer is disposed on the base film and has a second bending portion and a second flat portion connected to the second bending portion. The second bending portion is conformal to the first bending portion, and the second flat portion is conformal to the first flat portion.

In an embodiment of the invention, a gap exists between the first bending portion of the base film and the LED chip.

In an embodiment of the invention, the gap is an air gap or a vacuum gap.

In an embodiment of the invention, the first bending portion is an arc structure.

In an embodiment of the invention, the first bending portion has a roof portion and a sidewall portion connected to the roof portion, the roof portion is parallel to the first flat portion, and the sidewall portion is perpendicular to the first flat portion.

In an embodiment of the invention, a material of the base film includes polymethyl methacrylate (PMMA), polycarbonate (PC), polyethylene terephthalate (PET), polyethylene (PE), polypropylene (PP), polyvinyl alcohol (PVA), polyvinyl chloride (PVC) or polyurethane (PU).

In an embodiment of the invention, the fluorescent layer includes an adhesive and a fluorescent powder. The fluorescent powder includes a red fluorescent powder, a blue fluorescent powder, a yellow fluorescent powder, a green fluorescent powder or a combination thereof.

In an embodiment of the invention, the first bending portion includes a first sub-bending portion and a second sub-bending portion. The first sub-bending portion and the second sub-bending portion have a seamless connection therebetween and have a first recessed region. The second bending portion includes a third sub-bending portion and a fourth sub-bending portion. The third sub-bending portion and the fourth sub-bending portion have a seamless connection therebetween and have a second recessed region. The third sub-bending portion and the fourth sub-bending portion are respectively conformal to the first sub-bending portion and the second sub-bending portion. The second recessed region is disposed corresponding to the first recessed region, and the LED chip is disposed corresponding to the first recessed region.

The invention provides a method for manufacturing a wavelength converting structure, which includes following steps. A base film is provided, and the base film has an upper surface and a lower surface opposite to each other. A fluorescent layer is formed on the upper surface of the base film. The base film and the fluorescent layer are disposed in a mold to perform a thermocompression bonding process, such that the base film has a first bending portion and a first flat portion connected to the first bending portion, and the fluorescent layer has a second bending portion and a second flat portion connected to the second bending portion. The second bending portion is conformal to the first bending portion, and the second flat portion is conformal to the first flat portion. The mold is removed.

In an embodiment of the invention, the step of disposing the base film and the fluorescent layer into the mold to perform the thermocompression bonding process includes following steps. The mold including a male mold and a female mold is provided, where the lower surface of the base film contacts the male mold, and the fluorescent layer contacts the female mold. The thermocompression bonding process is performed on the mold, the base film and the fluorescent layer to deform the base film and the fluorescent layer through the mold.

In an embodiment of the invention, the method for manufacturing the wavelength converting structure further comprises performing a cooling process on the mold, the deformed base film and the deformed fluorescent layer after the thermocompression bonding process is performed and before the mold is removed.

According to the above descriptions, since the fluorescent layer of the wavelength converting structure of the invention has the design of the bending portion, and the base film is conformal to the fluorescent layer, when the wavelength converting structure covers the LED chip on the carrier, the wavelength converting structure does not directly contact the LED chip. In this way, the wavelength converting structure is not attenuated under heat, and has better device characteristic.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a cross-sectional view of a wavelength converting structure according to an embodiment of the invention.

FIG. 1B is a cross-sectional view of the wavelength converting structure of FIG. 1A covering a light-emitting diode (LED) chip on a carrier.

FIG. 2 is a cross-sectional view of a wavelength converting structure according to another embodiment of the invention.

FIG. 3 is a cross-sectional view of a wavelength converting structure according to another embodiment of the invention.

FIGS. 4A-4D are cross-sectional views of a process for manufacturing a wavelength converting structure according to an embodiment of the invention.

### DETAILED DESCRIPTION OF DISCLOSED EMBODIMENTS

FIG. 1A is a cross-sectional view of a wavelength converting structure according to an embodiment of the invention. Referring to FIG. 1A, in the present embodiment, the wavelength converting structure 100a includes a base film 110a and a fluorescent layer 120a. In detail, the base film 110a has a first bending portion 112a and a first flat portion 114a connected to the first bending portion 112a. The fluorescent layer 120a is disposed on the base film 110a and has a second bending portion 122a and a second flat portion 124a connected to the second bending portion 122a. The second bending portion 122a is conformal to the first bending portion 112a, and the second flat portion 124a is conformal to the first flat portion 114a. In detail, the base film 110a and the fluorescent layer 120a of the present embodiment has a same shape. As shown in FIG. 1A, the first bending portion 112a and the first flat portion 114a have a height difference H1 therebetween, and the second bending portion 122a and the second flat portion 124a also have a height difference H2 therebetween, where the height difference H1 can be greater than, smaller than or equal to the height difference H2, which is not limited by the invention.

FIG. 1B is a cross-sectional view of the wavelength converting structure of FIG. 1A covering a light-emitting diode (LED) chip on a carrier. Referring to FIG. 1B, when the wavelength converting structure 100a covers the carrier 10 carrying at least one LED chip 20 (one LED chip is schematically illustrated in FIG. 1B), the first flat portion 114a of the base film 110a is disposed and fixed on the carrier 10, and an accommodating space S is defined by the first bending portion 112a of the base film 110a and the carrier 10, and the LED chip 20 is disposed in the accommodating space S. In detail, in the present embodiment, the first bending portion 112a of the base film 110a and the LED chip 20 have a gap G therebetween. Preferably, the gap G is an air gap or a vacuum gap. Namely, the wavelength converting structure 100a does not directly contact the LED chip 20. In this way, the wavelength converting structure 100a is not attenuated under heat, and has better device characteristic.

As shown in FIG. 1A and FIG. 1B, the first bending portion 112a of the base film 110a is embodied as an arc structure, and the second bending portion 122a of the fluorescent layer 120a is also embodied as an arc structure. Certainly, in other embodiments, referring to FIG. 2, a first bending portion 112b of a base film 110b of a wavelength converting structure 100b can be composed of a roof portion 113b and a sidewall portion 115b connected to the roof portion 113b, where the roof portion 113b is parallel to a first flat portion 114b, and the sidewall portion 115b is perpendicular to the first flat portion 114b. Since a fluorescent layer 120b and the base film 110b have the same shape, a second bending portion 122b of the fluorescent layer 120b is also composed of a roof portion 123b and a sidewall portion 125b connected to the roof portion 123b, where the roof portion 123b is parallel to a second flat portion 124b, and the sidewall portion 125b is perpendicular to the second flat portion 124b. The above description is still a technical solution of the invention without departing from a protection range of the invention.

Moreover, a material of the base film 110a includes polymethyl methacrylate (PMMA), polycarbonate (PC), polyethylene terephthalate (PET), polyethylene (PE), polypropylene (PP), polyvinyl alcohol (PVA), polyvinyl chloride (PVC), polyurethane (PU), silicone or epoxy. Further, the base film 110a must have a high light transmittance and a low material deformation degree in order to form a high quality wavelength converting structure. Preferably, the material of the base film 110a includes polymethyl methacrylate (PMMA), polycarbonate (PC), polyethylene terephthalate (PET), polyethylene (PE), polypropylene (PP), polyvinyl alcohol (PVA), polyvinyl chloride (PVC) or polyurethane (PU). The fluorescent layer 120a is composed of an adhesive 126a and a fluorescent powder 128a, where the fluorescent powder 128a includes a red fluorescent powder, a blue fluorescent powder, a yellow fluorescent powder, a green fluorescent powder or a combination thereof, which is not limited by the invention. Moreover, the fluorescent layer 120a of the present embodiment is directly adhered on the base film 110a, and is fixed on the carrier 10 through the base film 110a. A part of light emitted from the LED chip 20 can penetrate through the base film 110a to excite the fluorescent powder 128a in the fluorescent layer 120a to generate an excitation light, another part of light emitted from the LED chip 20 can directly penetrate through the base film 110a and the adhesive of the fluorescent layer 120a to produce a mixing light, for example, a white light with the excitation light.

FIG. 3 is a cross-sectional view of a wavelength converting structure according to another embodiment of the invention. Reference numbers of the components and a part of contents of the aforementioned embodiment are also used in the present embodiment, wherein the same reference numbers denote the same or like components, and descriptions of the same technical contents are omitted. The aforementioned embodiment can be referred for descriptions of the omitted parts, and detailed descriptions thereof are not repeated in the present embodiment.

Referring to FIG. 3, in the present embodiment, the first bending portion 112c of the base film 110c includes a first sub-bending portion 112c1 and a second sub-bending portion 112c2. The first sub-bending portion 112c1 and the second sub-bending portion 112c2 have a seamless connection therebetween, i.e. are formed integrally, and have a first recessed region C1. A first flat portion 114c is connected to edges of the first sub-bending portion 112c1 and the second sub-bending portion 112c2. The first sub-bending portion 112c1, the second sub-bending portion 112c2 and the carrier 10 commonly define an accommodating space S′, and the LED chip 20 is located in the accommodating space S′, and is disposed corresponding to the first recessed region C1.

The fluorescent layer 120c of the present embodiment is disposed on the base film 110c, and the second bending portion 122c thereof includes a third sub-bending portion 122c1 and a fourth sub-bending portion 122c2. The third sub-bending portion 122c1 and the fourth sub-bending portion 122c2 have a seamless connection therebetween, i.e. are fondled integrally, and have a second recessed region C2. The second flat portion 124c is connected to edges of the third sub-bending portion 122c1 and the fourth sub-bending portion 122c2. Particularly, the third sub-bending portion 122c1 and the fourth sub-bending portion 122c2 of the second bending portion 120c are respectively conformal to the first sub-bending portion 112c1 and the second sub-bending portion 112c2 of the first bending portion 110c, and a position of the second recessed region C2 corresponds to a position of the first recessed region C1.

Since the fluorescent layer 120c of the wavelength converting structure 100c of the present embodiment has the second recessed region C2, after the light emitted from the LED chip 20 passes through the fluorescent layer 120c, an irradiation angle θa thereof can be increased to about 160 degrees. Namely, the irradiation light shape of the whole light-emitting device (including the carrier 10, the LED chip 20 and the wavelength converting structure 100c) has a wide angle. In this way, the light-emitting device complies with a light shape specification of a streetlight.

Only the structures of the wavelength converting structures 100a and 100b of the invention are introduced above, and the method for manufacturing the wavelength converting structures 100a and 100b is not introduced. Accordingly, the method for manufacturing the wavelength converting structure 100a is described in a following embodiment, and the wavelength converting structure 100a with the bending portion of an arc structure is taken as an example for description, and the method for manufacturing the wavelength converting structure 100a is described in detail below with reference of FIGS. 4A-4D.

FIGS. 4A-4D are cross-sectional views of a process for manufacturing a wavelength converting structure according to an embodiment of the invention. Referring to FIG. 4A, according to the method for manufacturing the wavelength converting structure 100a of the present embodiment, first, a base film 110a is provided, where the base film 110a has an upper surface 111a and a lower surface 111b opposite to each other. The material of the base film 110a is, for example, polymethyl methacrylate (PMMA), polycarbonate (PC), polyethylene terephthalate (PET), polyethylene (PE), polypropylene (PP), polyvinyl alcohol (PVA), polyvinyl chloride (PVC), polyurethane (PU), silicone or epoxy.

Then, referring to FIG. 4B, a fluorescent layer 120a is formed on the upper surface 111a of the base film 110a, where the fluorescent layer 120a is, for example, adhered on the base film 110a through coating, though the invention is not limited thereto. The fluorescent layer 120a is composed of an adhesive 126a and a fluorescent powder 128a, and the fluorescent powder 128a includes a red fluorescent powder, a blue fluorescent powder, a yellow fluorescent powder, a green fluorescent powder or a combination thereof, which is not limited by the invention.

Then, referring to FIG. 4C, the base film 110a and the fluorescent layer 120a are disposed in a mold M to perform a thermocompression bonding process, such that the base film 110a has a first bending portion 112a and a first flat portion 114a connected to the first bending portion 112a, and the fluorescent layer 120a has a second bending portion 122a and a second flat portion 124a connected to the second bending portion 122a. The second bending portion 122a is conformal to the first bending portion 112a, and the second flat portion 124a is conformal to the first flat portion 114a.

In detail, referring to FIG. 4C, the step of disposing the base film 110a and the fluorescent layer 120a into the mold M to perform the thermocompression bonding process includes following steps. First, the mold including a male mold M1 and a female mold M2 is provided. The lower surface 111b of the base film 110a contacts the male mold M1, and the fluorescent layer 120a contacts the female mold M2. Then, the thermocompression bonding process is performed on the mold M, the base film 110a and the fluorescent layer 120a to deform the base film 110a and the fluorescent layer 120a through the mold M, so as to form the base film 110a having the first bending portion 112a and the first flat portion 114a and form the fluorescent layer 120a having the second bending portion 122a and the second flat portion 124a.

Then, a cooling process can be performed on the mold M and the deformed base film 110a and the fluorescent layer 120a, so as to cure the base film 110a and the fluorescent layer 120a. Finally, referring to FIG. 4D, the mold M is removed to complete the wavelength converting structure 100a having the bending portion design.

Since the wavelength converting structure 100a of the present embodiment is manufactured through the mold M based on the thermocompression bonding process, none bubble is generated during the manufacturing process of the wavelength converting structure 100a compared to the conventional technique of forming the fluorescent layer through a mold filling method, such that the conventional problems that the bubbles influence the refractive index of the fluorescent layer and spoil an appearance thereof are avoided. Moreover, in the present embodiment, the fluorescent layer 120a is first evenly coated on the upper surface 111a of the base film 110a, and then the thermocompression bonding process is performed by using the mold M to form the bending portion (the first bending portion 112a and the second bending portion 122a) and the flat portion (the first flat portion 114a and the second flat portion 124a). Therefore, the problem that the amount of the fluorescent adhesive and position of the fluorescent powder at a junction of the base and the fluorescent layer cannot be controlled by using the conventional mold filling method is avoided. Moreover since the wavelength converting structure 100a is manufactured by using the mold M according to the thermocompression bonding process, a thickness and an appearance of the wavelength converting structure 100a can be changed by adjusting a distance and shapes of the male mold M1 and the female mold M2.

In summary, since the fluorescent layer of the wavelength converting structure of the invention has the design of the bending portion, and the base film is conformal to the fluorescent layer, when the wavelength converting structure covers the LED chip on the carrier, the wavelength converting structure does not directly contact the LED chip. In this way, the wavelength converting structure is not attenuated under heat, and has better device characteristic. Moreover, since the wavelength converting structure is manufactured through the mold according to the thermocompression bonding process, none bubble is generated during the manufacturing process, and the wavelength converting structure may have better device characteristic and appearance. Moreover, a thickness and the appearance of the wavelength converting structure can be changed through the mold, by which manufacturing flexibility of the wavelength converting structure is improved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A wavelength converting structure, adapted to cover a carrier carrying at least one light-emitting diode (LED) chip, the wavelength converting structure comprising:
a base film, having a first bending portion and a first flat portion connected to the first bending portion, wherein the first flat portion is disposed on the carrier, an accommodating space is defined by the first bending portion and the carrier, and the LED chip is disposed in the accommodating space; and
a fluorescent layer, disposed on the base film, and having a second bending portion and a second flat portion connected to the second bending portion, wherein the second bending portion is conformal to the first bending portion, and the second flat portion is conformal to the first flat portion.

2. The wavelength converting structure as claimed in claim 1, wherein a gap exists between the first bending portion of the base film and the LED chip.

3. The wavelength converting structure as claimed in claim 2, wherein the gap is an air gap or a vacuum gap.

4. The wavelength converting structure as claimed in claim 1, wherein the first bending portion is an arc structure.

5. The wavelength converting structure as claimed in claim 1, wherein the first bending portion has a roof portion and a sidewall portion connected to the roof portion, the roof portion is parallel to the first flat portion, and the sidewall portion is perpendicular to the first flat portion.

6. The wavelength converting structure as claimed in claim 1, wherein a material of the base film comprises polymethyl methacrylate (PMMA), polycarbonate (PC), polyethylene terephthalate (PET), polyethylene (PE), polypropylene (PP), polyvinyl alcohol (PVA), polyvinyl chloride (PVC) or polyurethane (PU).

7. The wavelength converting structure as claimed in claim 1, wherein the fluorescent layer comprises an adhesive and a fluorescent powder, the fluorescent powder comprises a red fluorescent powder, a blue fluorescent powder, a yellow fluorescent powder, a green fluorescent powder or a combination thereof.

8. The wavelength converting structure as claimed in claim 1, wherein the first bending portion comprises a first sub-bending portion and a second sub-bending portion, the first sub-bending portion and the second sub-bending portion have a seamless connection therebetween and have a first recessed region, the second bending portion comprises a third sub-bending portion and a fourth sub-bending portion, the third sub-bending portion and the fourth sub-bending portion have a seamless connection therebetween and have a second recessed region, the third sub-bending portion and the fourth sub-bending portion are respectively conformal to the first sub-bending portion and the second sub-bending portion, the second recessed region is disposed corresponding to the first recessed region, and the LED chip is disposed corresponding to the first recessed region.

9. A method for manufacturing a wavelength converting structure, comprising:
providing a base film, wherein the base film has an upper surface and a lower surface opposite to each other;
forming a fluorescent layer on the upper surface of the base film;
disposing the base film and the fluorescent layer in a mold to perform a thermocompression bonding process, such that the base film has a first bending portion and a first flat portion connected to the first bending portion, and the fluorescent layer has a second bending portion and a second flat portion connected to the second bending portion, wherein the second bending portion is conformal to the first bending portion, and the second flat portion is conformal to the first flat portion; and
removing the mold.

10. The method for manufacturing the wavelength converting structure as claimed in claim 9, wherein the step of disposing the base film and the fluorescent layer into the mold to perform the thermocompression bonding process comprises:
providing the mold having a male mold and a female mold, wherein the lower surface of the base film contacts the male mold, and the fluorescent layer contacts the female mold; and
performing the thermocompression bonding process on the mold, the base film and the fluorescent layer to deform the base film and the fluorescent layer through the mold.

11. The method for manufacturing the wavelength converting structure as claimed in claim 10, further comprising:
performing a cooling process on the mold, the deformed base film and the deformed fluorescent layer after the thermocompression bonding process is performed and before the mold is removed.
